(19) United States
(12) Patent Application Publication
(10) Pub. No.: US 2025/0381460 A1
(43) Pub. Date: Dec. 18, 2025

(54) PIECE OF SPORTS EQUIPMENT FOR TRANSMITTING FORCE

(71) Applicant: KUNSTSTOFFWERK AG BUCHS, Buchs (CH)

(72) Inventors: Holger KNAUST, Neuenburg am Rhein (DE); Martin RUDOLPH, Nüziders - Vorarlberg (AT)

(21) Appl. No.: 19/153,796

(22) PCT Filed: Feb. 6, 2024
(86) PCT No.: PCT/CH2024/050004

§ 371 Date: Sep. 3, 2025

(30) Foreign Application Priority Data
Feb. 7, 2023 (CH) CH000110/2023

(51) Int. Cl. A63B 59/70; A63B 102/24

(52) U.S. Cl. CPC A63B 59/70; A63B 2102/24

(57) ABSTRACT

A piece of sports equipment, in particular a portable piece of sports equipment, including an elongate hollow semi-finished product and a planar element for transmitting force. The elongate semi-finished product has an opening at its first longitudinal end and is connected to the planar element at said first longitudinal end. According to the invention, the planar element includes thermoplastic material and is moulded onto the elongate hollow semi-finished product.

### TECHNICAL FIELD OF THE INVENTION

The invention relates to a piece of sports equipment comprising an elongate hollow semi-finished product and a planar element, wherein the elongate hollow semi-finished product is connected to the planar element at a first longitudinal end, according to the preamble of claim 1. The invention furthermore relates to a method for producing a piece of sports equipment according to claim 22.

### BACKGROUND OF THE INVENTION

Pieces of sports equipment can consist of several component parts. On the one hand, the various component parts are exposed to different loads and thus need a different design and/or material selection. On the other hand, the production of a plurality of component parts, which are brought together at the end to form a piece of sports equipment, can be more cost-efficient.

There is growing demand for the use of thermoplastics for the production of pieces of sports equipment. Especially the formation of certain component parts of a piece of sports equipment by means of thermoplastics is desired thereby. The thermoplastic materials have the advantage that they provide for a simple production even in the case of complex geometries and combine a high resistance against mechanical loads with a relatively low weight.

As a rule, the joining and the connection of a component part made of thermoplastic material with a further component part is established by means of adhesion with the help of an adhesive attached between the two component parts. The adhesive connection created therewith requires a separate production step in the production process, whereby the production costs increase. At the same time, adhesive connections have a deep resistance against continuous loads or shearing effects.

A hockey stick with a hollow shaft and a blade attached thereto is shown in U.S. Pat No. 4,358,113A. The blade can be made of a plastic. It has two elongate elements, which stick out from the blade and which can be inserted into the hollow shaft. The blade is provided to be firmly connected, after melting the elements together with the shaft, to the shaft via the elements. The blade has a core made of a plastic, wherein the core can be encased by a layer with unidirectional fibers.

A hockey stick is shown in DE 29 11 512 A1, the shaft of which is connected to the blade by means of a countersunk pin. The shaft can be made of any material, whereas the blade consists of plastic. With the help of the countersunk pin, for example in the form of an elongate truncated cone, a press-fit connection is created between the blade and the shaft. In order to achieve a good mechanical connection to the blade, the countersunk pin is provided with circular or oval depressions at least on a portion of its surface.

### OBJECT

It is thus an object of the present invention to show an alternative piece of sports equipment, which comprises at least two component parts, wherein the connection of the component parts has a high resistance against mechanical loads.

### DESCRIPTION

The object is solved by means of a piece of sports equipment with the features of patent claim 1.

The piece of sports equipment comprises an elongate, hollow semi-finished product and a planar element for transmitting force. The elongate semi-finished product has an opening at its first longitudinal end and is connected to the planar element at said first longitudinal end. The piece of sports equipment is characterized in that the planar element comprises thermoplastic material and is molded onto the elongate semi-finished product.

An elongate semi-finished product is characterized by its pronounced expansion in one dimension, which thus forms the longitudinal direction. The expansion in the longitudinal direction is several times larger than the expansion perpendicular to the longitudinal direction. The length of the elongate semi-finished product is at least five times larger than its width or height. The cross section of the elongate semi-finished product can have any shape thereby. The elongate semi-finished product is empty in its interior, whereby it has a hollow structure. The elongate hollow semi-finished product can also be formed by means of an elongated frame, wherein in this example, the length is perpendicular to the surface, which is spanned by the frame.

The planar element arranged on the elongate semi-finished product has a pronounced expansion in two dimensions, wherein the expansion in the third dimension forms the thickness of the planar element. The expansion in the first two dimensions forms the largest surface of the planar element. The width or length of this surface is several times larger, at least five times larger, than the thickness of the planar element in each case.

The planar element is provided to be molded onto the elongate semi-finished product and is, for this purpose, produced in an injection molding process. The thermoplastic material is injected into a mold, in which the elongate semi-finished product is at least partly received. The planar element is thus molded onto the elongate semi-finished product.

The injection molding process provides for a cheap production of the planar element, wherein more complex geometries can also be created comparatively cost-efficiently. The thermoplastic can be used selectively to form complex geometries and offers the advantage that no machining is required subsequently.

According to the invention, the planar element is molded onto the elongate semi-finished product. The molding of the thermoplastic provides for the creation of a substance-to-substance bond, non-positive and/or positive connection to the elongate semi-finished product. The connection between the planar element and the elongate semi-finished product thus has a larger resistance against mechanical loads.

The advantageous embodiment variations mentioned below, alone or in combination according to the invention, lead to further improvements of the piece of sports equipment according to the invention.

According to an advantageous embodiment, the thermoplastic material has single-layer or multi-layer unidirectional fiber stacks. The fiber stack in the thermoplastic material increases the resistance against mechanical loads. Due to the fact that fiber stacks can absorb a comparatively large tensile force, they are suitable for objects, which are subjected to bending stresses. The advantage of unidirectional fiber stacks is, for example, that they can be aligned selectively and thus increase the bending resistance of the piece of sports equipment in a certain direction.

In a preferred embodiment, a connecting element is arranged between the elongate semi-finished product and the planar element. The connecting element can serve as connecting link between the elongate semi-finished product and the planar element, whereby the connection would be formed due to the connecting element. However, it can also be used as an element, which only reinforces the connection.

The connecting element is advantageously arranged, in particular inserted, in the opening of the elongate semi-finished product. The elongate semi-finished product has an opening at its first longitudinal end. The connecting element can be arranged therein in order to create a connection, which is robust and the production of which is simple at the same time, between the connecting element and the elongate semi-finished product. The insertion of the connecting element into the opening of the elongate semi-finished product forms a further option for a cheap production method.

The connecting element preferably has a limiting surface for the planar element, up to which the planar element protrudes. The limiting surface of the connecting element serves as the limiting surface of the planar element, while the latter is molded onto the longitudinal end of the elongate semi-finished product. The planar element can thus expand only up to the limiting surface of the connecting element during the injection process, which leads to an efficient material use.

The connecting element advantageously has a front surface and a cutout, wherein the limiting surface comprises the front surface and the inner side of the cutout. The front surface forms the first contact surface of the planar element with the limiting surface. The cutout, the inner side of which serves as limiting surface, can be used to be filled during the production of the planar element in order to create a positive connection, for example, after cooling down.

The cutout preferably comprises a continuous opening through the connecting element. The continuous opening in the connecting element makes it possible for the planar element, which fills this opening, to protrude over the connecting element and to come into contact with the elongate semi-finished product.

The front surface is preferably connected to the continuous opening via at least one channel. The channel can be used to guide the planar element from the side of the front surface into the continuous opening. The channel forms the simplest structure for fulfilling this task. Several channels can also be arranged at any positions of the front surface.

The front surface is ideally arranged perpendicular to the longitudinal direction of the elongate semi-finished product. In the case of a perpendicular arrangement of the front surface, the planar element protrudes equally far into the elongate semi-finished product, distributed over the cross section, which, in turn, provides for a more efficient use the material.

In a preferred embodiment, the planar element has a positive connection to the elongate semi-finished product. Due to the fact that the planar element is molded onto the elongate semi-finished product, the geometry of the elongate semi-finished product can be selected in such a way that a positive connection results between both component parts after the injection process. Compared to a non-positive connection, the positive connection has a higher resistance against mechanical loads, in particular against continuous loads, which are to be expected when using a piece of sports equipment according to the invention.

The planar element preferably forms an undercut in the elongate hollow semi-finished product. The undercut can be created during the production process of the planar element because the latter is molded onto the elongate semi-finished product.

The connecting element preferably comprises the same or related material as the planar element. The use of the same or related material offers a larger selection of connecting options between both component parts.

The connecting element preferably has a substance-to-substance bond with the planar element. A strong and resistant connection is established between the connecting element and the planar element by means of a substance-to-substance bond. Due to the fact that the planar element serves the purpose of transmitting force from or to the piece of sports equipment, a strong connection of the planar element to the connecting element is of great importance for the stability and the long-term behavior of the piece of sports equipment.

In an alternative embodiment to the above embodiment, the connecting element has a positive connection to the planar element. The creation of a positive connection between the connecting element and the planar element can be more favorable from a production-related aspect because any material selection can be made.

The connecting element advantageously has a non-positive connection to the elongate semi-finished product. The non-positive connection allows attaching the connecting element more easily to the elongate semi-finished product, whereby a resistant connection can nonetheless be formed therewith.

In a preferred embodiment, the connecting element, the planar element and the elongate semi-finished product are in contact with one another. All three component parts have a contact to the two other component parts and thus mutually touch one another. This leads to a compact structure, which simultaneously simplifies the creation of resistant connections among the component parts.

The connecting element is preferably surrounded by the hollow semi-finished product and/or by the planar element, so that the connecting element is not visible from the outside. The connecting element can thus have a shape and color, which does not influence the overall appearance of the piece of sports equipment. This, in turn, provides, for example, for the production of a connecting element, which is always the same, for different pieces of sports equipment, which can strongly reduce the production costs.

The elongate hollow semi-finished product preferably forms a shaft, a shank and/or a handle of the piece of sports equipment. The elongate semi-finished product thus serves the purpose of holding and/or applying a torque when using the piece of sports equipment. The planar element has the task of transmitting the force to a medium or an object. The elongate hollow semi-finished product in the form of a shaft, a shank and/or a handle provides for the transmission of force from the athlete to the planar element.

The planar element preferably consists of thermoplastic material. This can lead to a more cost-efficient production of the planar element because the planar element would thus not have any further dissimilar components.

In a further preferred embodiment, the elongate, hollow semi-finished product comprises aluminum and/or a thermosetting plastic and/or a thermoplastic material. A material is thus used, which has a low density and which leads to a small mass of the elongate semi-finished product and thus also of the entire piece of sports equipment. This can be of great importance, for example, for a portable piece of sports equipment.

The elongate hollow semi-finished product advantageously has a wall thickness from 0.5 mm to 10 mm, preferably from 1 mm to 5 mm. The wall thickness of the elongate semi-finished product has a direct influence on the weight of the piece of sports equipment. The elongate semi-finished product thus has an upper limit of its wall thickness because the elongate semi-finished product unnecessarily increases in weight in the case of a larger wall thickness. The minimum wall thickness of the elongate semi-finished product is due to its required strength. A wall thickness smaller than 0. 5 mm can lead to a quick failure in response to mechanical load.

A further aspect of the invention relates to a method for producing a piece of sports equipment, in particular a portable piece of sports equipment. The method steps comprise—providing an elongate hollow semi-finished product, wherein the elongate hollow semi-finished product has an opening at a first longitudinal end;
arranging the elongate hollow semi-finished product into a casting mold, wherein the first longitudinal end of the semi-finished product comes to rest in the casting mold and the casting mold has a planar volume;
injecting thermoplastic into the casting mold until the thermoplastic protrudes to the elongate semi-finished product; and
curing the thermoplastic, so that a positive connection is created between the thermoplastic and the hollow elongate semi-finished product.

The piece of sports equipment has a limiting surface, up to which the thermoplastic spreads.

The limiting surface offers the advantage that it forms a boundary for the thermoplastic, up to which the thermoplastic can expand. This is of great importance in particular when molding onto a hollow semi-finished product because the entire hollow space of the semi-finished product thus does not need to be filled with the thermoplastic.

The piece of sports equipment preferably has a connecting element, which comprises the limiting surface. The use of a connecting element to form the limiting surface allows for a modular structure, whereby low production costs can be achieved, in turn.

The connecting element advantageously comprises thermoplastic material and enters into a substance-to-substance bond with the injected thermoplastic during the injection molding process. If the connecting element has thermoplastic material, the injected thermoplastic can partially melt the surface of the connecting element due to its temperature. A substance-to-substance bond can thus be achieved after curing the thermoplastic.

The connecting element is preferably inserted into the opening at the first longitudinal end of the elongate hollow semi-finished product. The opening at the longitudinal end of the elongate semi-finished product lends itself for receiving the connecting element. By arranging the connecting element in the opening at the longitudinal end of the elongate semi-finished product, said opening is simultaneously closed, which strongly simplifies the use of an injection molding process.

The connecting element has a front surface, which lies flush with the end of the elongate semi-finished product in the installed state. The connecting element can have bulges, extensions or adapters, which protrude from the front surface. The mentioned bulges, extensions and the adapter have in common that they form three-dimensional geometric shapes, which are arranged on the front side of the connecting element and which are provided to be encompassed by the planar element. The geometric shape is characterized in that the largest expansion is in the direction of the length. The expansion in the width can vary, depending on the shape. While extensions can be tongue-shaped, for example, and can have a tapering away from the front surface, an adapter can also have a widening of its cross sectional surface. This means that the adapter of the connecting element can have a width, which is larger than the width of the remaining connecting element and of the elongate semi-finished product. The adapter thus has a cross sectional surface, which first increases away from the front surface of the connecting element until the largest cross sectional surface is reached and subsequently decreases and becomes zero. During the production of the piece of sports equipment, the planar element is molded onto the elongate semi-finished product and onto the connecting element. As a result of this, the elements of the connecting element, which protrude away from the front surface, are completely enclosed by the planar element. When using the same or similar materials between the connecting element and the planar element, a substance-to-substance bond can be created thereby. When using different materials, in contrast, the material of the planar element can be selected in such a way that the planar element experiences a shrinking due to the cool-down after the injection process. A shrink-fit can thus form between the connecting element and the planar element. The adapter forms an undercut and the planar element is connected to the connecting element by means of positive connection due to the shrink-fit. The planar element ideally has a thickness of at least 2 mm. This thickness is required in order to ensure the required stability at the connecting point with the connecting element.

The mentioned optional features can be realized in any combination, provided that they are not mutually exclusive. Further preferred ranges of combinations of the minima and maxima mentioned in the ranges result in particular where preferred ranges are specified.

### BRIEF DESCRIPTION OF THE FIGS.

Exemplary embodiments of the invention will be described in an exemplary manner below on the basis of the figures. In schematic illustration, not to scale:

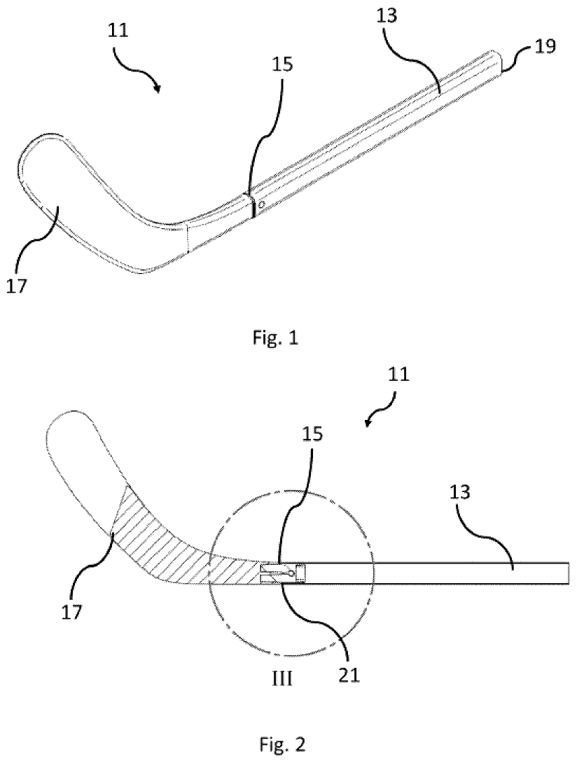

FIG. 1: shows a three-dimensional view of a hockey stick according to the invention;

FIG. 2: shows a longitudinal section through the hockey stick from FIG. 1;

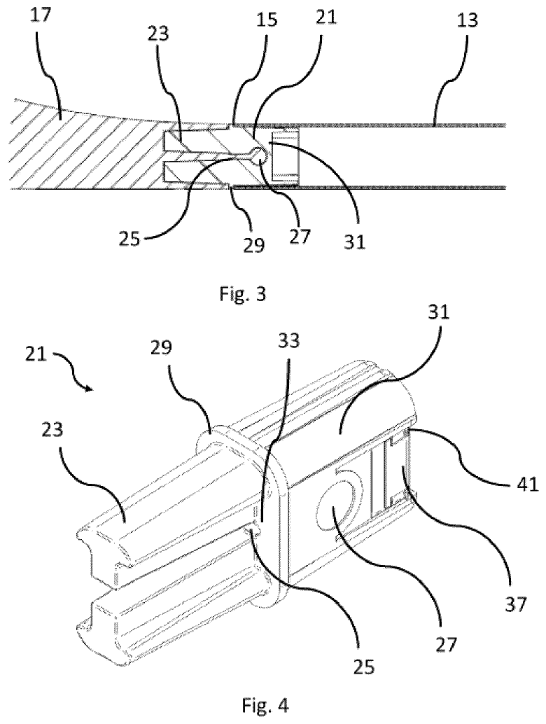

FIG. 3: shows an enlarged illustration of the connecting point of the hockey stick from FIGS. 1 and 2;

FIG. 4: shows a perspective view of a connecting element;

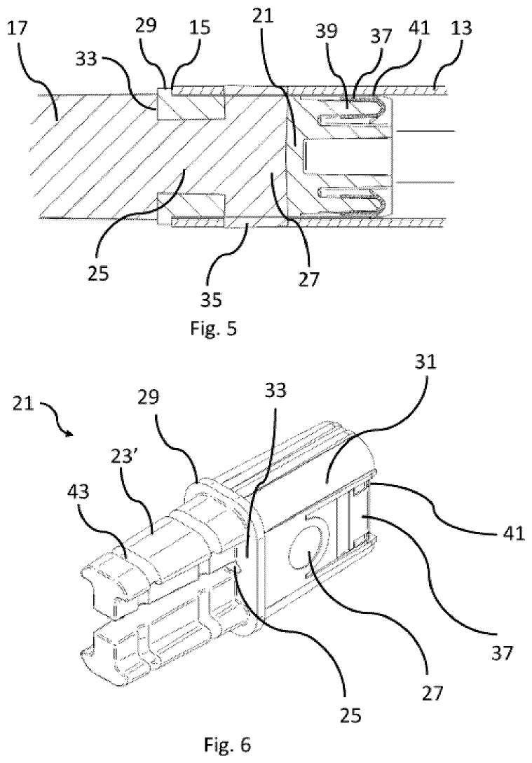

FIG. 5: shows a longitudinal section through the hockey stick perpendicular section from FIG. 2;

FIG. 6: shows a perspective view of an alternative connecting element;

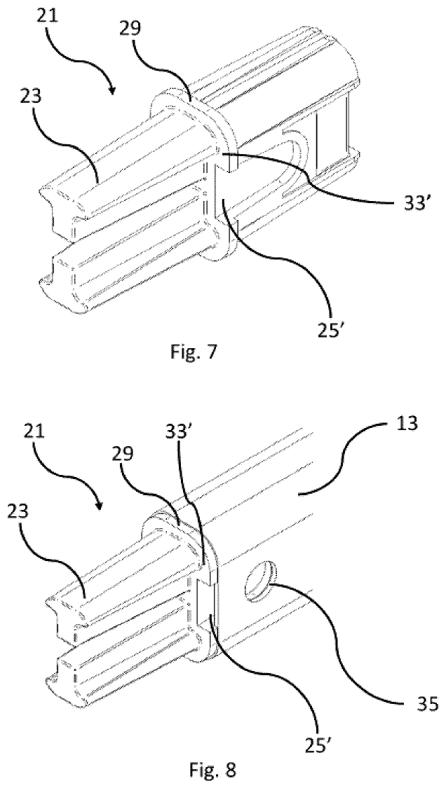

FIG. 7: shows a perspective view of a connecting element with two inlet channels;

FIG. 8: shows a perspective view of a connecting element shown in FIG. 7 into a hollow elongate semi-finished product;

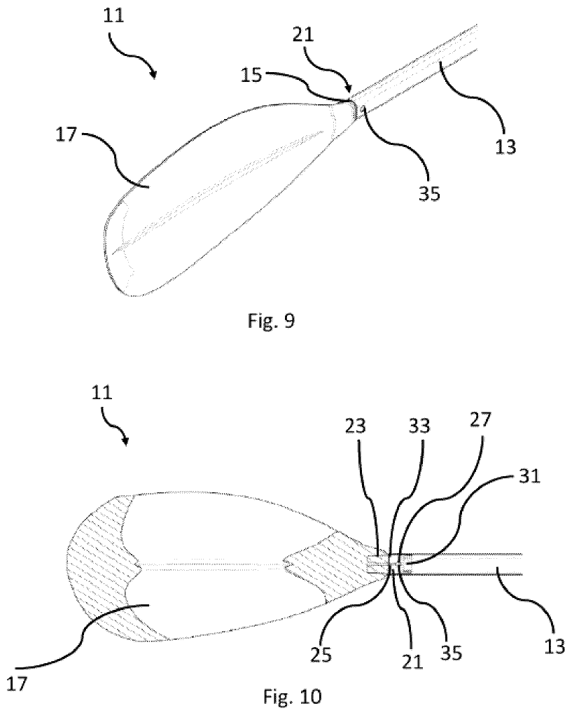

FIG. 9: shows a perspective view of a paddle according to the invention;

FIG. 10: shows a longitudinal section through the paddle from FIG. 9;

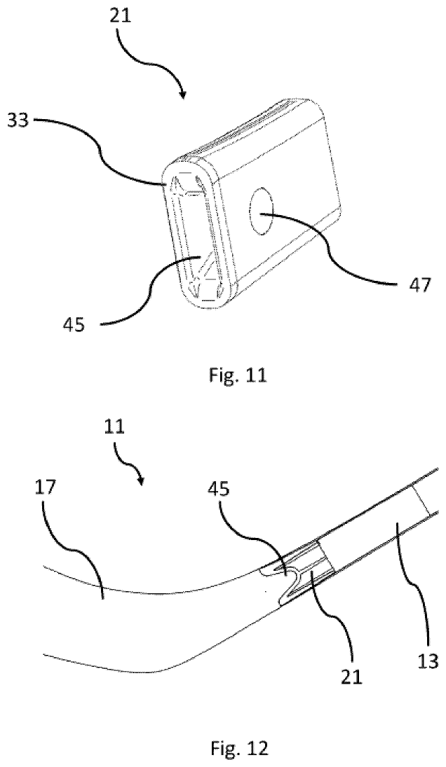

FIG. 11: shows a three-dimensional view of an alternative connecting element;

FIG. 12: shows a longitudinal section through a hockey stick with a connecting element from FIG. 11;

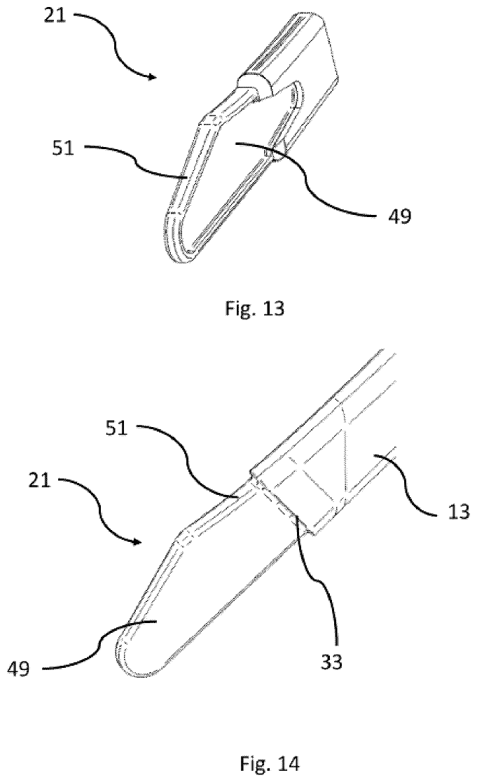

FIG. 13: shows a three-dimensional view of a further embodiment of a connecting element;

FIG. 14: shows a three-dimensional view of a similar embodiment of a connecting element as in FIG. 13 attached to the elongate semi-finished product;

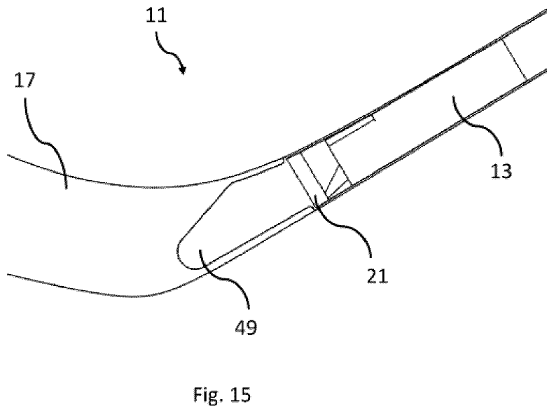

FIG. 15: shows a longitudinal section through a hockey stick with a connecting element from FIG. 14.

### DETAILED DESCRIPTION OF THE FIGURES

In the following, identical reference numerals represent identical or functionally identical elements (in different figures). An additional apostrophe can serve the purpose of differentiating similar or functionally identical, respectively, or functionally similar elements in a further embodiment.

A hockey stick is shown in FIG. 1 as a piece of sports equipment 11. The hockey stick 11 has a shaft, which is formed by an elongate hollow semi-finished product 13. A blade is attached as a planar element 17 at the first longitudinal end 13 of the shaft 13. The shaft 13 is provided to be held by a person at the second longitudinal end 19. For this purpose, the shaft 13 can have a separate handle (not shown in Figure). The shaft 13 and the blade 17 can be made of the same as well as of different materials. The shaft 13 has a hollow structure, in that the interior space of the shaft 13 is empty. The blade 17 is formed by a planar element, wherein the planar element 17 has a shank for connection to the longitudinal end of the shaft. The planar element 17 mainly serves the purpose of transmitting force to an object, with which the planar element 17 comes into contact.

A longitudinal section of the hockey stick 11 from FIG. 1 along its longitudinal axis is illustrated in FIG. 2. A connecting element 21 is arranged between the shaft 13 and the blade 17. The connecting element 21 is inserted into the shaft 13 with one end, while the opposite end of the connecting element 21 protrudes into the blade 17.

The arrangement of the connecting element 21 between the shaft 13 and the blade 17 is shown in more detail in FIG. 3. The connecting element 21 comprises an insertion section 31, which is inserted into the shaft 13. The connecting element 21 has two tongue-shaped extensions 23, which expand towards the blade 17 in the longitudinal direction of the shaft. An inlet channel 25, through which the material of the blade can reach into a transverse channel 27 in the connecting element 21 during the molding, is provided between the extensions 23. The connecting element 21 has a rim 29, which sticks out and which is arranged approximately in the center of its longitudinal direction and runs perpendicular to the longitudinal direction in the circumferential direction. The connecting element 21 is dimensioned in such a way that after insertion of the connecting element into the shaft 13, the rim 29 of the connecting element comes to rest on the edges of the shaft 13 at the longitudinal end thereof. The transverse channel 27 of the connecting element is separated from the hollow space of the shaft 13 by means of the connecting element itself. The connecting element is thus in contact with the blade 17 and the shaft 13.

A possible embodiment of a connecting element 21 is illustrated in FIG. 4. The connecting element 21 comprises an insertion section 31, which is inserted into the shaft.

The insertion section 31 is closed by a front surface 33. The front surface 33 is surrounded by a rim 29, which sticks out. The connecting element 21 has tongue-shaped extensions 23, which stick out approximately perpendicularly from the front surface 33. The extensions 23 have an approximately constant cross section and a length of approximately half the connecting element 21. A cutout is furthermore present in the front surface 33.

The cutout is placed between the extensions. The cutout serves as inlet channel 25 for the access to the transverse channel 27, which is arranged in the insertion section 31 of the connecting element 21. The transverse channel 27 is arranged perpendicular to the longitudinal direction of the shaft 13 and of the above-mentioned inlet channel 25, wherein the inlet channel 25 leads into said transverse channel 27. In the embodiment shown in FIG. 4, the transverse channel 27 is cylindrical and is formed by a continuous bore.

FIG. 5 shows the cross sectional plane of the hockey stick 11 perpendicular to the longitudinal section from FIG. 3. Only the insertion section 31 of the connecting element 21 is illustrated because the tongue-shaped extensions 23 lie above or below the sectional plane. The inlet channel 25 in the connecting element 21 has a larger width than height. Opposite cutouts 35, which come to rest in a flush manner with one another and with the bore of the transverse channel 27 of the connecting element, are provided in the shaft 13. Together, the shaft 13 and the connecting element 21 thus have a continuous opening from one to the opposite side of the shaft 13. The blade 17 fills the volume of the transverse channel 27 in the connecting element 21 and the cutouts 35 in the shaft in such a way that the blade 17 lies flush with the outer rim of the cutouts 35 in the shaft. This thus results in a ring-shaped contact surface between the blade 17 and the shaft 13.

As shown in FIG. 4, the connecting element 21 can have clamps 37 in its insertion section 31. Said clamps are introduced via a rib 39 of the connecting element 21 and are advantageously fixed thereto by means of a frictional connection. The clamps 37 at the connecting element have prongs 41, which stick out outwards. The prongs 41 protrude from the connecting element 21 to the extent that they are in contact with the shaft 13 when the connecting element 21 is inserted into the shaft 13. The tips of the prongs 41 protrude from the connecting element 21, but are inclined in the direction of the front surface 33.

FIG. 6 shows an alternative embodiment of the connecting element 21. This embodiment differs from the embodiment from FIG. 4 in the design of the tongue-shaped extensions 23′. In FIG. 6, the tongue-shaped extensions 23′ each have two depressions 43. The depressions 43 run perpendicular to the longitudinal direction of the extension 23′ and cover three of the four longitudinal sides. The two sides of the extensions 23′ facing one another do not have a depression. In the completely produced piece of sports equipment, the depressions 43 are filled with the material of the planar element. A further positive connection can thus be established between the planar element 17 and the connecting element 21 via the depressions.

A further alternative embodiment of a connecting element 21 is shown in FIG. 7. The tongue-shaped extensions 23 of the connecting element 21 from FIG. 7 are embodied identically as those of the connecting element from FIG. 4. They protrude perpendicularly from the front surface 33′. In contrast to the embodiment from FIG. 4, the front surface 33′ of the connecting element 21 has two cutouts in FIG. 7, which each form an inlet channel 25, whereby only one inlet channel 25′ can be seen in the figure. The inlet channel 25′ is formed as part of a cutout, which protrudes from the front surface 33′ approximately to the center of the insertion section and which is arranged on two opposite outer sides of the connecting element 21.

In FIG. 8, the connecting element 21 shown in FIG. 7 is inserted into an elongate semi-finished product 13, which can be a shaft 13, for example. The cutouts, of which the inlet channels 25 are a part, rest against that location of the inner side of the elongate semi-finished product 13, at which the cutouts 35 are attached to the elongate semi-finished product 13. The cutouts in the connecting element 21, of which the inlet channels 25 are a part, are not connected to one another in the embodiment shown in FIG. 8. During the injection molding of a planar element 17 onto the connecting element 21′ from FIG. 8, the material of the planar element 17 flows around the tongue-shaped extensions 23 of the connecting element 21, spreads over the front surface 33′ and reaches via the inlet channels 25′ all the way to the cutouts 35 in the elongate semi-finished product. After curing of the planar element 17, a positive connection is formed between the planar element 17, the elongate semi-finished product 13 and the connecting element 21.

FIG. 9 shows an alternative embodiment of a piece of sports equipment 11 according to the invention. The piece of sports equipment 11 is formed by a paddle. The paddle 11 comprises a shaft, which is formed by an elongate hollow semi-finished product 13. A paddle blade, which is formed by a planar element 17, is arranged on the first longitudinal end 15 of the shaft 13. The paddle blade 17 is molded onto the first longitudinal end 15 of the shaft. In the embodiment shown in FIG. 9, the cross section of the shaft 13 is selected to be rectangular, but can also be round or elliptical. The paddle blade 17 is fixed to the shaft 13 via a connecting element 21. The shaft 13 has two opposite cutouts 35, in which the connecting element 21, for example, is arranged and forms an undercut. From the connecting point between the paddle blade 17 and the shaft 13, the paddle blade has two diverging edges, which span the surface of the paddle blade 17 until the two edges are brought together again over approximately a semi-circle. The length of the paddle blade 17 runs parallel to the longitudinal direction of the shaft 13 thereby and is approximately twice as large as its width. Due to the fact that the paddle blade 17 is formed by a planar element, it has a smaller thickness compared to its length and width. The thickness of the paddle blade is thus at least five times smaller than its width. The paddle blade 17 has a reinforcing rib, which is aligned in the longitudinal direction and extends over a large portion of the paddle blade.

A longitudinal section through approximately the center of the paddle 11 from FIG. 9 is shown in FIG. 10. A connecting element 21 is arranged between the shaft 13 and the paddle blade 17. This is an embodiment of a connecting element 21, which is shown in FIG. 4. The connecting element 21 is inserted with its insertion section 31 at the first longitudinal end 15 of the shaft 13 into the latter. The connecting element 21 has a transverse channel 27, which is formed by a through bore. The cutout 35 on the shaft comes to rest in a flush manner with this through bore. A channel 25 leads from the transverse channel 27 to the front surface 33 of the connecting element. On the front surface 33, the connecting element has two tongue-shaped extensions 23, which stick out and which expand in the direction of the paddle blade 17. After the insertion of the connecting element 21 into the shaft 13, the paddle blade 17 is molded on. The paddle blade 17 fills the inlet channel 25 and the transverse channel 27 of the connecting element 21 as well as the cutouts 35 on the shaft. The paddle blade 17 is thus positively connected to the connecting element 21 and the shaft 13. At the same time, the connecting element 21 is likewise positively connected to the shaft 13. The paddle blade 17 can have a reinforcement in the form of embedded fiber stacks. The shaded regions in FIG. 10 show the fiber-reinforced regions of the paddle blade 17. The direction of the lines shows a possible alignment of unidirectional fibers in the fiber stack thereby.

An alternative embodiment of a connecting element 21 is shown in FIG. 11. The connecting element 21 has a cuboidal structure. The longitudinal sides are formed in such a way that the connecting element 21 can be inserted along the longitudinal sides into an opening of an elongate hollow semi-finished product 13. The front side 33 of the connecting element 21 is arranged perpendicular to the longitudinal sides. A recess 45, which protrudes approximately up to a third of the connecting element 21, is provided on the front side 33. The recess 45 tapers with increasing depth. The recess 45 simultaneously forms a limiting surface for the planar element 17 when the latter is molded on. A circular cutout 47 is in each case attached to the longitudinal sides of the connecting element at the end of the recess 45. During the production of a piece of sports equipment, the material of the planar element reaches from the inside of the connecting element 21 to the outside through this cutout 47. Ideally, the connecting element 21 is inserted into an elongate hollow semi-finished product 13, which likewise has two opposite circular cutouts 35, which come to rest in a flush manner with the cutouts 47 of the connecting element. The material of the planar element can thus reach from the recess 45 of the connecting element via the cutout 47 of the connecting element into the cutout 35 of the elongate hollow semi-finished product during the production of a piece of sports equipment 11 with the connecting element 21 from FIG. 11. As a result, a positive connection between the planar element 17 to the connecting element 21 as well as to the elongate semi-finished product 13 results.

A longitudinal section through a hockey stick as piece of sports equipment 11 is shown in FIG. 12, in the case of which the connection between the blade and the shaft is formed via a connecting element 21 as from FIG. 11. The material of the blade thereby protrudes all the way into the recess 45 of the connecting element, wherein the cutouts 47 of the connecting element are not visible in this illustration.

FIG. 13 shows a further possible embodiment of a connecting element 21. In contrast to the embodiment from FIG. 12, the limiting surface is not created by a recess but by an adapter 49 protruding outwards here. The adapter 49 extends in the longitudinal axial direction away from the connecting element 21. On its edges 51, the adapter 49 has an increased thickness, wherein, aside from the edges 51, the thickness of the adapter is even. The adapter 49 has an expansion, which changes over the length thereof, in the width direction. The width increases away from the remaining connecting element 21, until a maximum width is reached, and then decreases consistently again, so that the adapter 49 has a hand axe-like shape.

A connecting element 21 on an elongate semi-finished product 13 is illustrated in FIG. 14, which has an adapter 49, which protrudes away from the elongate semi-finished product 13 and from the remaining connecting element 21. The adapter 49 has a cuboidal shape with a rounded width, wherein its thickness is even and is smaller than the thickness of the connecting element 21. The adapter 49 has two rounded opposite longitudinal edges, which do not run parallel to one another. While the first longitudinal edge runs parallel to the longitudinal axis of the elongate semi-finished product 13, the second longitudinal edge consists of a diverging and a converging partial piece. The width of the adapter 49, which is defined by the distance between the two opposite edges, is thus largest at the point of the change from the diverging into the converging partial piece. This maximum width of the adapter 49 can be larger than the width of the elongate semi-finished product 13.

A longitudinal section through a hockey stick is shown, in turn, in FIG. 15, which has a connecting element 21, which is shown in FIG. 14. The planar element 17, which forms the blade of the hockey stick, completely surrounds the adapter 49 of the connecting element 21. The material of the blade is only in contact with the connecting element 21, which, in turn, is attached in the elongate semi-finished product 13. A positive connection between the blade and the connecting element 21 results by means of the molding of the blade onto the connecting element 21 as well due to the shape of the adapter 49. If the material of the blade differs from the material of the connecting element 21, a shrink fit can be created between the blade and the connecting element 21 after cool-down and shrinking of the blade.

Even if the embodiment of a hockey stick as piece of sports equipment is shown in the figures, a non-exhaustive list of further embodiments of a piece of sports equipment according to the invention comprises tennis rackets, table tennis paddles, badminton rackets, paddles or oars, golf clubs and paddle tennis rackets.

A production method of an embodiment option of the piece of sports equipment according to the invention with the use of a connecting element is shown below:

The elongate hollow semi-finished product is provided. It can be made of a plastic as well as of a metal. At least one longitudinal end of the elongate semi-finished product has to have an opening. Ideally, the entire surface is present in a free manner on the longitudinal end. A connecting element is inserted into said opening. The connecting element comprises an insertion section, which is closed by a limiting surface, and tongue-shaped extensions or protrusions, which stick out from a front surface. In a preferred embodiment, the connecting element comprises thermoplastic material, wherein the tongue-shaped extensions or protrusions ideally consist of a thermoplastic. The front surface is arranged approximately in the center of the connecting element and has a rim, which sticks out in the circumferential direction. After insertion of the connecting element into the semi-finished product, the rim of the connecting element comes to rest on the edges of the opening of the semi-finished product. The insertion direction of the connecting element forms the longitudinal direction of the connecting element. Starting at the front surface, the insertion section of the connecting element has a channel in the longitudinal direction of the connecting element, which leads into a transverse channel. The transverse channels extends over the entire width of the connecting element and is designed in the form of a through bore. Cutouts, which come to rest in a flush manner with the through bore when placing the connecting element in the semi-finished product in the connecting element, are arranged in the semi-finished product on two opposite sides.

After insertion of the connecting element into the semi-finished product, the semi-finished product is placed into a casting mold. Due to the fact that a planar element is to be created by means of the injection molding process, the casting mold has a planar hollow space with a smaller height compared to the length and width. The casting mold encloses the semi-finished product in the circumferential direction and has a hollow space, which adjoins the connecting element, so that the connecting element does not come into contact with the casting mold. Thermoplastic material is injected into the hollow space of the casting mold. The thermoplastic material spreads in the entire hollow space of the casting mold and flows through the channel all the way into the transverse channel at the connecting element. The thermoplastic material is limited in the transverse channel by means of the casting mold, which encloses the semi-finished product, so that the thermoplastic material is flush with the outer side of the elongate semi-finished product. After the cool-down of the molded-on thermoplastic material, the latter forms a positive connection with the connecting element due to the transverse channel and with the hollow elongate semi-finished product due to the opposite cutouts.

In the case of an embodiment of the tongue-shaped extensions or protrusions by means of thermoplastic material, they melt upon contact with the hot injected thermoplastic and a substance-to-substance bond forms on the extensions between the connecting element and the thermoplastic molded thereon during the subsequent cool-down.

While specific embodiments have been described above, it is obvious that different combinations of the shown embodiment options can be used, provided that they are not mutually exclusive.

### LIST OF REFERENCE NUMERALS

11 piece of sports equipment
13 hollow elongate semi-finished product
15 first longitudinal end
17 planar element
19 second longitudinal end
21 connecting element
23 tongue-shaped extension
25 inlet channel
27 transverse channel
29 rim of the connecting element, which sticks out
31 insertion section
33 front surface
35 cutout in the shaft
37 clamp
39 rib in the connecting element
41 prong
43 depressions on the connecting element
45 recesses of the connecting element
47 cutouts at longitudinal sides of the connecting element
49 adapter
51 edge of the adapter

1.-25. (canceled)

26. A piece of sports equipment, in particular portable piece of sports equipment, comprising an elongate hollow semi-finished product and a planar element for transmitting force, wherein the elongate semi-finished product has an opening at its first longitudinal end and is connected to the planar element at said first longitudinal end, wherein the planar element comprises thermoplastic material and is molded onto the elongate semi-finished product.

27. The piece of sports equipment according to claim 27, wherein the thermoplastic material has single-layer or multi-layer unidirectional fiber stacks.

28. The piece of sports equipment according to claim 28, wherein a connecting element is arranged between the elongate hollow semi-finished product and the planar element.

29. The piece of sports equipment according to claim 29, wherein the connecting element is inserted in the opening of the elongate hollow semi-finished product.

30. The piece of sports equipment according to claim 29, wherein the connecting element has a limiting surface for the planar element, up to which the planar element protrudes.

31. The piece of sports equipment according to claim 30, wherein the connecting element has a front surface and a cutout, wherein the limiting surface comprises the front surface and the inner side of the cutout.

32. The piece of sports equipment according to claim 31, wherein the cutout comprises a continuous opening through the connecting element.

33. The piece of sports equipment according to claim 32, wherein the front surface is connected to the continuous opening via at least one channel.

34. The piece of sports equipment according to claim 31, wherein the front surface is arranged perpendicular to the longitudinal direction of the elongate hollow semi-finished product.

35. The piece of sports equipment according to claim 26, wherein the planar element has a positive connection to the elongate hollow semi-finished product.

36. The piece of sports equipment according to claim 35, wherein the planar element forms an undercut in the elongate hollow semi-finished product.

37. The piece of sports equipment according to claim 28, wherein the connecting element comprises the same or related material as the planar element.

38. The piece of sports equipment according to claims 28, wherein the connecting element has a substance-to-substance bond with the planar element.

39. The piece of sports equipment according to claim 28, wherein the connecting element has a positive connection to the planar element.

40. The piece of sports equipment according to claims 28, wherein the connecting element has a non-positive connection to the elongate hollow semi-finished product.

41. The piece of sports equipment according to claim 28, wherein the connecting element, the planar element and the elongate hollow semi-finished product are in contact with one another or that all three component parts are in mutual contact, respectively.

42. The piece of sports equipment according to claim 28, wherein the connecting element is surrounded by the elongate hollow semi-finished product and/or by the planar element, so that the connecting element is not visible from the outside.

43. The piece of sports equipment according to claim 26, wherein the elongate hollow semi-finished product forms a shaft, a shank and/or handle of the piece of sports equipment.

44. The piece of sports equipment according to claim 26, wherein the planar element consists of thermoplastic material.

45. The piece of sports equipment according to claim 26, wherein the elongate hollow semi-finished product comprises aluminum and/or a thermosetting plastic and/or a thermoplastic material.

46. The piece of sports equipment according to claim 26, wherein the elongate hollow semi-finished product has a wall thickness from 0.5 mm to 10 mm, preferably from 1 mm to 5 mm.

47. A method for producing a piece of sports equipment, in particular a portable piece of sports equipment, comprising the method steps;
providing an elongate hollow semi-finished product, wherein the elongate hollow semi-finished product has an opening at a first longitudinal end,
arranging the elongate hollow semi-finished product into a casting mold, wherein the first longitudinal end comes to rest in the casting mold and the casting mold has a planar volume,
injecting thermoplastic into the casting mold until the thermoplastic protrudes to the elongate hollow semi-finished product, curing the thermoplastic, so that a positive connection is created between the thermoplastic and the hollow elongate semi-finished product, wherein the piece of sports equipment has a limiting surface, up to which the thermoplastic spreads.

48. The method according to claim 47, wherein the piece of sports equipment has a connecting element, which comprises the limiting surface.

49. The method according to claim 47, wherein the connecting element comprises thermoplastic material and enters into a substance-to-substance bond with the injected thermoplastic.

50. The method according to claim 47, wherein the connecting element is inserted into the opening at the first longitudinal end of the elongate hollow semi-finished product.
